(19) United States
(12) Patent Application Publication
(10) Pub. No.: US 2006/0186138 A1
(43) Pub. Date: Aug. 24, 2006

(54) Bin for dispensing bulk material

(76) Inventor: Ronald Brundick, Roland, AR (US)

Correspondence Address: ELEY LAW FIRM CO., 7870 OLENTANGY RIVER RD, SUITE 311, COLUMBUS, OH, 43235, US

(21) Appl. No.: 11/360,954

(22) Filed: Feb. 23, 2006

Related U.S. Application Data
(60) Provisional application No. 60/655,521, filed on Feb. 23, 2005.

(51) Int. Cl. B67D 5/38

(52) U.S. Cl. 222/158

(57) ABSTRACT

A material dispensing bin for storage and measured dispensing of powdered, ground, chopped or granulated material such as spices, seasonings, herbs, teas and dry chemicals, among others. The bin has a body comprising a reservoir for storing the materials and a handle for ease of handling the bin. A dispensing chute is connected, via a feed port, to the body and provides a holding chamber for measuring the quantity of material to be dispensed and may include a volumetric metering device. The bin may be agitated to assist transfer of the materials to the dispensing chute. To dispense the materials a dispensing mechanism comprising a manually depressed button actuates a stopper along one end of the dispensing chute to release a pre-measured quantity of material. A spout along the dispensing end of the dispensing chute may be provided to assist in funneling the dispensed materials into a desired container.

This application claims priority to U.S. provisional application 60/655,521, filed Feb. 23, 2005, the contents of which are hereby incorporated by reference.

### FIELD OF THE INVENTION

The present invention relates generally to a container for dispensing materials. In particular, the present invention relates to a dispenser for apportioning and dispensing finely ground, chopped or powdered bulk materials, such as spices, teas, herbs and powders.

### BACKGROUND

Gravity fed bins for dispensing bulk materials are used to dispense a wide variety of materials having a range of sizes and aggregate make-ups as diverse as hardware components, e.g., nuts and bolts, to food, e.g., pastas, cereals, nuts, coffee (either beans or ground), dried soup mixes, candies, spices, and the like. Generally, the bins are comprised of enclosures having an inlet at an upper end utilized to fill a cavity, an outlet or chute at its lower end utilized to dispense the material, and a flow control device located between the upper and lower openings for controlling the amount of material being dispensed during the time the control device is actuated. In operation, as the material is being dispensed, gravity pulls the remaining material in the cavity towards the lower end to replace the dispensed material. These types of bins generally include a downwardly angled or curving inner wall that forms a slide to channel the dispensed materials into a receptacle adjacent the outlet. Examples of prior art gravity fed bins can be found in U.S. Pat. Nos. 6,182,864 and 6,241,123 to Elmore, U.S. Pat. No. 4,903,866 to Loew, NewLeaf Designs' Vita-Bin® gravity bin product, and BestBins Corporation's gravity bin products.

Gravity fed bins offer a multitude of advantages compared to other dispensing means, such as scoop bins, including convenience, ease of use and hygiene. Even so, gravity fed bins are not well suited for all types of materials, thus preventing them from being more widely adopted. Specifically, gravity fed dispensers are not generally well suited for dispensing finely ground, chopped or otherwise powdered products, such as spices, teas, herbs and powders, that tend to bridge over the dispensing area and since it is desirable to dispense spices in much more controlled, and most often smaller, predetermined quantities.

Heretofore, the most practical means for dispensing such difficult to dispense finely ground product was to employ a bulk food dispenser generally known as a “scoop bin.” As the name suggests, a scoop bin typically comprises a plastic bin, often having a hinged lid that is lifted to provide the consumer access to the stored contents. A hand scoop is then employed to gather the bulk product for placement into a container. While scoop bins are effective for dispensing a wider variety of product than a gravity type dispenser, they suffer from several major disadvantages, particularly in the area of hygiene, because of the contamination that can take place in these types of dispensers. Sources of contamination include germs that may be attached to the scoop or scoop handle being transferred to the stored product during dispensing or from external debris falling into the bin cavity when the bin's lid is lifted. Lastly, since the nature of scoop bins requires their openings to be located closer to the floor for access reasons, they are generally within the reach of children and others who are not hesitant to reach into the unsecured bins with potentially unclean hands in order to extract a sample, or even play with the bin contents.

Attempts have been made to address one or more of these problems. For example, U.S. Pat. No. 5,054,934 to Kintz shows a sanitary dispensing bin for such things as spices wherein the bins include a vanes and a sieve in juxtaposition with a sleeve for mixing and dispensing a predetermined amount of bulk materials. U.S. Pat. No. 6,601,734 to Smith shows a relatively hygienic device for measuring and dispensing free flowing materials. U.S. Pat. No. 6,093,430 to Gupta shows a prepackaged variety spices, specifically collected for a given recipe, in the measured amounts called for in that recipe. Unfortunately, none of these attempts adequately address the problems encountered in the dispensing of finely ground or powdered bulk materials, especially in a retail setting.

There remains a need for a reliable bulk product dispenser that can be easily cleaned, whose contents are neither easily accessible nor prone to external contamination, that can accommodate a wide variety of finely ground or powdered bulk products and which is capable of dispensing those granular or powdered materials in predetermined portions.

### SUMMARY

A material dispensing bin is disclosed according to an embodiment to the present invention. The present invention addresses and overcomes the shortcomings inherent in previous attempts in the art to dispense finely ground, chopped or powdered products. In particular, the present invention overcomes the tendency of components of the stored product to exert tactile pressure upon each other such that the components bridge a dispensing opening in the housing or clump together. The present invention provides for manual agitation when the consumer handles the sealed spice bin, thus overcoming any bridges or clumps which may occur in the bulk granular or powdered materials. The present invention may also provide a graduated chute that enables the consumer to pre-measure the amount of bulk materials to be dispensed. The dispensing chute may also be fitted with a metering device to limit the amount of materials to be dispensed at any given time.

An object of the present invention is a material dispensing bin comprising a reservoir for storing granular or powdered material, a feed port, a dispensing chute, and a dispensing mechanism. Granular, chopped or powdered material is stored in the reservoir prior to dispensing. The feed port provides communication between the reservoir and dispensing chute. A determinable amount of the stored material is transferred from the reservoir to the dispensing chute by manually agitating the dispenser bin. The dispensing mechanism is then actuated to dispense the material in the desired amount.

Another object of the present invention is a material dispensing bin comprising a reservoir for storing materials for dispensing, a dispensing chute, a dispensing mechanism contained within the dispensing chute, and a feed port providing communication between the reservoir and the dispensing chute. The dispensing chute further comprises a tapered spout along a first end and a graduated holding chamber. The dispensing mechanism further comprises a plunger, a stopper attached along a first end of the plunger, a spring and a button attached along a second end of the plunger. The button is biased by the spring extending outwardly from a second end of the dispensing chute. The stopper is biased by the spring against a first end of the dispensing chute. The material dispensing bin is employed by storing the materials in the reservoir until dispensing. To dispense the stored materials a desired quantity of material is transferred from the reservoir through the feed port and into the holding chamber of the dispensing chute by manually agitating the material dispensing bin until the desired amount of spices is transferred to the holding chamber. The dispensing mechanism is manually actuated by depressing the button, thereby enabling the material in the holding chamber to be dispensed.

Yet another object of the present invention is a method for dispensing bulk granular, chopped or powdered material. Material may be dispensed by the method by filling a material dispensing bin reservoir with a desired material and storing the material within the material dispensing bin until ready for use. Dispensing may be achieved by orienting the material dispensing bin in a transfer orientation, i.e., placing the reservoir into a material transfer condition, and then manually agitating the material dispensing bin to cause the materials to flow through a feed port and into a dispensing chute. Next, the material dispensing bin is oriented in a dispensing orientation, i.e., generally upright to take the reservoir out of a material transfer condition, and the amount of material within the dispensing chute can measured using graduations along the surface of a holding chamber of the dispensing chute. If too much or too little material was transferred to the holding chamber the material dispensing bin is reoriented and agitated in either a storage orientation to shake material back into the reservoir or in the transfer orientation to shake more material into the holding chamber. This process is repeated until a desired amount of material is transferred to the dispensing chute holding chamber. In the alternative to using graduations to determine the amount of materials to be dispensed, the holding chamber may be fitted with a metering device, in which case the user need not refer to the graduations, if any, in order to dispense a predetermined volume of stored material. After transfer, the material dispensing bin is oriented in a dispensing orientation, that is, with the spout in a generally downward orientation, and the spout is positioned with respect to a desired receiving container into which the material is to be dispensed. The desired amount of material is then dispensed into the receiving container by actuating the dispensing mechanism.

Yet another aspect of the present invention is a method for dispensing finely ground, chopped or powdered bulk product. The method comprises the steps of providing a reservoir having a sealable opening, providing a port in the reservoir, the port being actuable between a closed position and an open position to selectively allow bulk product through the opening, providing a dispensing chute in communication with the reservoir for accepting a select portion of bulk materials, providing a spring-biased stopper at the spout end of the dispensing chute for retaining the pre-measured bulk materials prior to dispensing, and actuating a dispensing button to dispense the pre-measured portion of product through the chute's spout while simultaneously sealing the feed port of the reservoir. The method may also include providing a metering device within the dispensing chute for determining a select amount of materials to be dispensed.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a perspective view depicting the general arrangement of components of a material dispensing bin according to an embodiment of the present invention;

FIG. 2 is a side elevational, cross-sectional view of the material dispensing bin of FIG. 1 depicting components of the dispensing mechanism;

FIG. 3 is a bottom elevational view of the material dispensing bin of FIG. 1;

FIG. 4 is a front elevational view of the material dispensing bin of FIG. 1;

FIG. 5 is a top elevational view of the material dispensing bin of FIG. 1;

FIG. 6 is an elevational view of the spout of a material dispensing bin depicting threads along the outer surface of the spout according to an embodiment of the present invention;

FIG. 7 is an elevational view of the spout of a material dispensing bin depicting threads along the inner surface of the spout according to an embodiment of the present invention;

FIG. 8 is an elevational view of the spout of a material dispensing bin depicting a spout adapter according to an embodiment of the present invention;

FIG. 9 is a rear elevational view of eighteen spice dispensing bins of FIG. 1 depicted in storage orientation on a shelving unit;

FIG. 10a is a side elevational, cross-sectional view of the material dispensing bin of FIG. 1 depicting the bin in a storage orientation and bulk granular or powdered material partially filling the reservoir;

FIG. 10b.1 is a side elevational, cross-sectional view of the material dispensing bin of FIG. 1 depicting the bin in transfer orientation and granular or powdered material flowing into the dispensing chute;

FIG. 10b.2 is a side elevational, cross-sectional view of the material dispensing bin of FIG. 1 depicting the bin in transfer orientation and a measured amount of granular or powdered material ready to be dispensed;

FIG. 10c is a side elevational, cross-sectional view of the material dispensing bin of FIG. 1 depicting the bin in dispensing orientation and a measured amount of granular or powdered material being dispensed into a container;

FIG. 10d is a side elevational, cross-sectional view of the material dispensing bin of FIG. 1 depicting the bin in dispensing orientation and a measured amount of granular or powdered material being dispensed into a bag that is held in position by a user's fingers and bag grips;

FIG. 11 is a perspective view of a material dispensing bin according to another embodiment of the present invention;

FIG. 12 is a side elevational view of the material dispensing bin of FIG. 11;

FIG. 13 is a perspective view of the material dispensing bin of FIG. 11 depicting the location of labels along the rear of the bin;

FIG. 14 is a top elevational view of the material dispensing bin of FIG. 11;

FIG. 15 is a side elevational, cross-sectional view of the material dispensing bin of FIG. 11 depicting components of the dispensing mechanism;

FIG. 16 is a side elevational, exploded view of the material dispensing bin of FIG. 11 depicting the components of the dispensing mechanism;

FIG. 17 is a perspective view of a material dispensing bin according to a third embodiment of the present invention;

FIG. 18 is an exploded perspective view of the material dispensing bin of FIG. 17;

FIG. 19 is a perspective view of a material dispensing bin according to a fourth embodiment of the present invention; and

FIG. 20 is a perspective view of the material dispensing bin of FIG. 19 depicting the rear portion of the bin.

### DETAILED DESCRIPTION

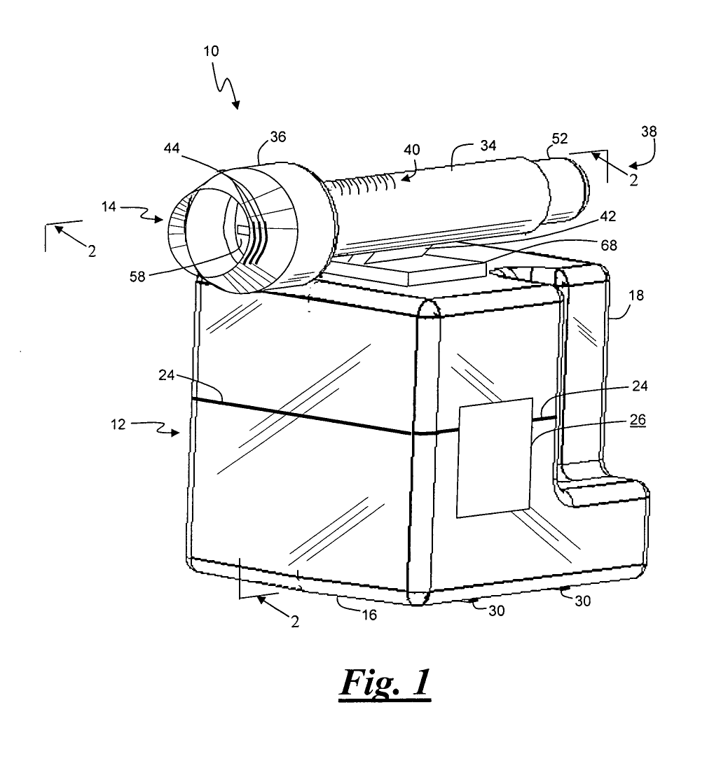

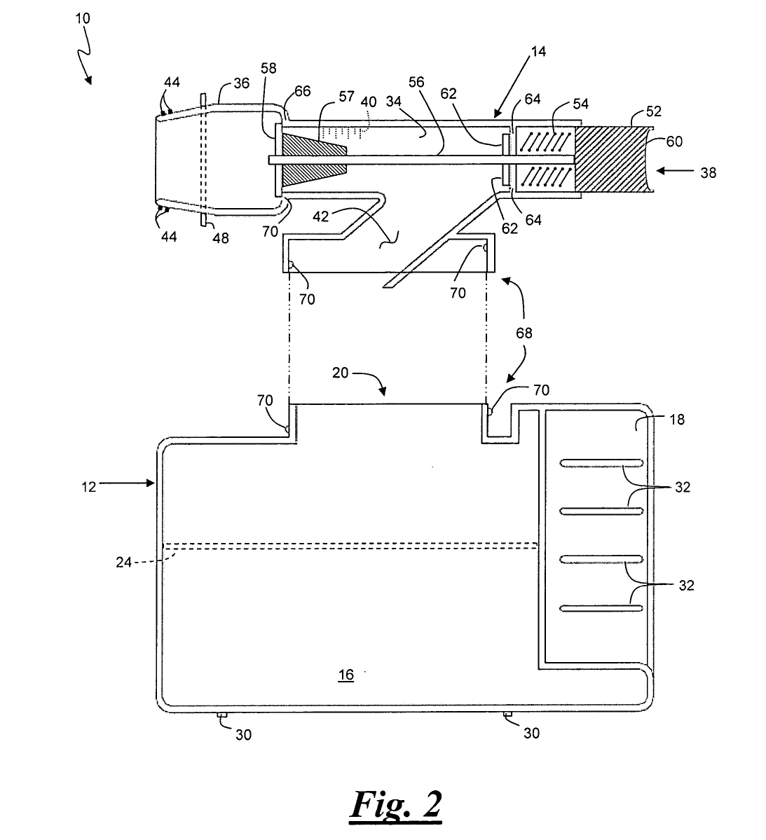

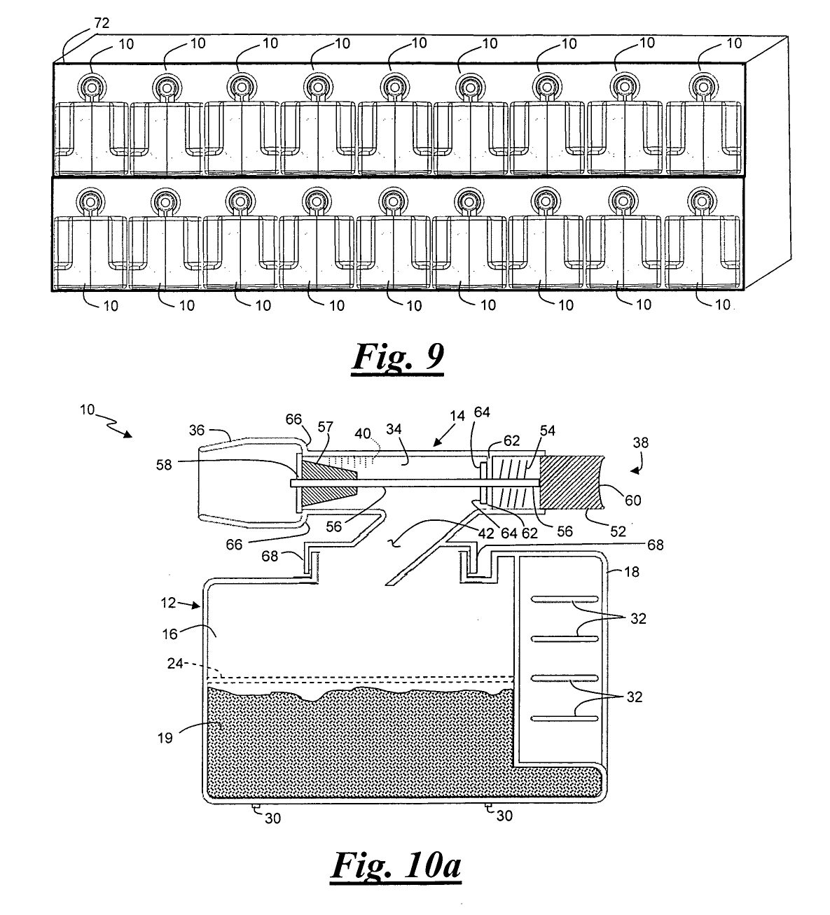

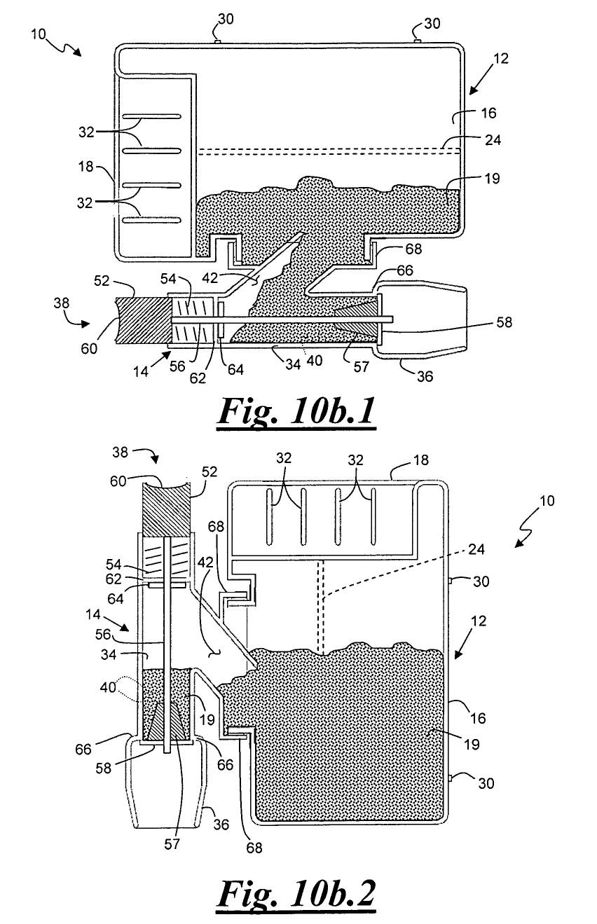

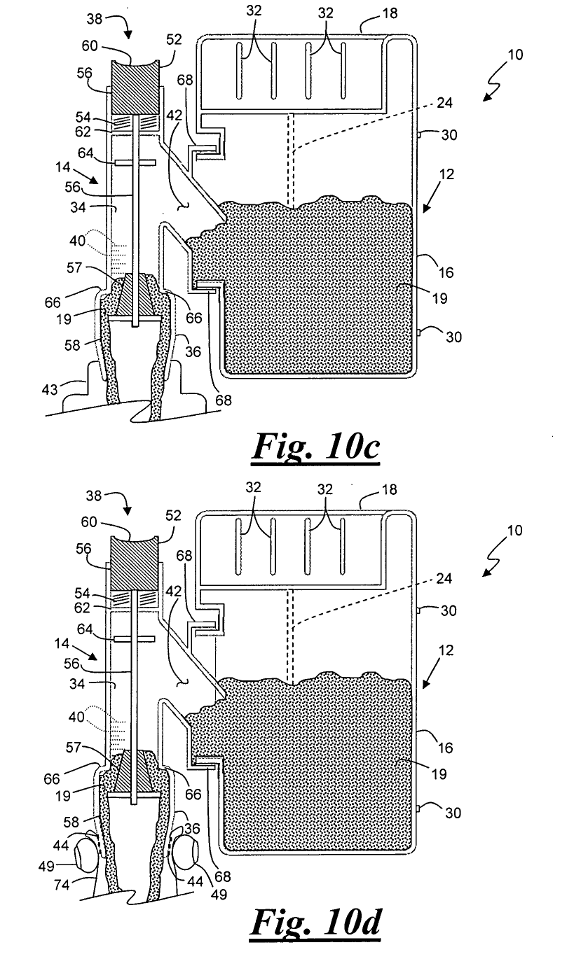

Referring to FIG. 1, a bin for dispensing bulk material (“bin”) 10 comprising a body 12 and a dispensing chute 14 is depicted according to an embodiment of the present invention. Body 12 further comprises a reservoir 16 and a handle 18. Reservoir 16 forms a hollow cavity inside which powdered, ground or other materials such as spices, teas, herbs, salts, dry chemicals, powders, ice cream toppings or other bulk product, among others, may be stored, hereinafter generally referred to as “material” 19, e.g., see FIGS. 10a-10d. Reservoir 16 may have any suitable shape but typically comprises a generally cuboidal form. The size of reservoir 16 is determined by design requirements such as volume and footprint, among others, and may provide compatibility with storage devices or units such as a shelving unit 72, as described in greater detail below and shown in FIG. 9, or drawers that are commonly employed in the art. Along one surface of reservoir 16 is a filling port 20 that provides access to the interior of the reservoir for filling with a desired material 19. Also, located on one or more exterior surfaces of reservoir 16, may be a fill line 24, as depicted in FIGS. 1 and 2. Fill line 24 indicates to a user of bin 10 the maximum recommended fill level for material 19 that should be placed within reservoir 16.

A label 26 may be attached along an exterior surface of reservoir 16, as depicted in FIG. 1 and anywhere else, as may be effective, to convey to the user indications of the material content of the 10. Label 26 may be fixedly attached directly to the exterior surface of reservoir 16 by glue, among other adhesives. Such labels 26 may be items such as a sticker or adhesive label. Alternatively, or in addition, a slot, pocket or envelope may be attached on the exterior surface of reservoir 16 such that label 26 may be inserted therein. A clip-on or snap-on label (not shown) attachable to bin 10 via a separate component that can clamp around, or onto a feature of the bin may also be employed. Labels 26 can also be molded, cut or otherwise scribed into the surface of reservoir 16 or integrated into bin 10 as a separate component during the construction of the bin. Generally, labels 26 are attached along side surfaces of reservoir 16, adjacent to handle 18 such that a user may easily view the label when holding bin 10 by the handle. Labels 26 can also be located on a portion of the rear surface of the bin along or below the handle to enable a user to view the label as the bin is stored, such as on a shelf or rack.

Along the bottom surface of body 12 may be located a plurality of runners or feet 30, as depicted in FIGS. 1-4. Feet 30 generally comprise ridges, tabs, lips or other features extending outwardly from the bottom surface of body 12 to provide a stable, level base upon which bin 10 rests during storage or non-use.

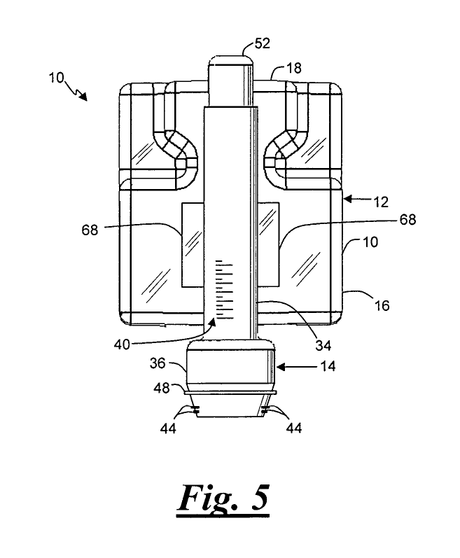

Referring now to FIG. 5 as well as to FIGS. 1 and 2, handle 18 extends from the rear portion of body 12. Handle 18 may generally be molded into or otherwise form a portion of reservoir 16 and has a reduced width with one or more concave portions situated longitudinally along either side of the handle to provide an easily and/or comfortably graspable feature by which a user picks up and manipulates bin 10. Handle 18 is typically hollow and thus contains a portion of the cavity comprising reservoir 16. Handle 18 may have along its surface one or more grips 32. Grips 32 comprise any surface feature along handle 18 that provides additional traction to a user for gripping and holding onto the handle, and as depicted in FIG. 2, generally comprise raised or recessed ridges along and transverse to the length of the handle. Other embodiments of bin 10 may exclude handle 18 or utilize handles of alternate designs, such as a solid, loop of material extending from the rear surface of the bin (not shown), among others, without detracting from the invention.

Reservoir 16 and handle 18 are generally formed as an integral component to produce body 12, as depicted in FIGS. 1-5, or may be separate components that are joined together. Further, body 12 can be constructed from a single piece of material, such as by blow molding or lost foam molding, among others, or produced in two or more pieces and later joined together. Such a multi-piece process may, for example, include molding body 12 as two half sections and then clamping, gluing, welding or ultrasonically bonding the sections together, among other methods.

Generally, body 12 may be constructed from substantially clear, molded plastic, but other color configurations are anticipated. Example materials include, without limitation, polycarbonates such as Lexan® produced by General Electric, Merlon® produced by Mobay Chemical Company, Markolon® produced by Bayer, and polyethylene terephthalates. For dispensers intended to dispense food-related material, it is also preferable to utilize materials that have been approved by the U.S. Food and Drug Administration and constructed in accordance with food service specifications promulgated by NSF International of Ann Arbor, Mich.

Referring again to FIGS. 1-5 in combination, dispensing chute 14 further comprises a holding chamber 34 and a spout 36 and contains a dispensing mechanism 38 within its structure. Holding chamber 34 is formed by a hollow section of any desirable cross-sectional shape, but is typically cylindrical. Holding chamber 34 generally extends along the length of bin 10 running from near the rear of the bin to near the front and has a length generally less than that of the bin. The length and interior volume of holding chamber 34 is determinable by design requirements, such as the desired volume available for dispensing material 19 or the desired overall size of bin 10, among others. As depicted in FIG. 1, graduations 40 may be located along an outer surface of holding chamber 34 which can be used to measure the amount of material contained within the holding chamber when the holding chamber is oriented in a generally vertical, dispensing orientation, as described below. See FIG. 10b.2. Graduations 40 can be applied in any desirable unit of measurement to provide any suitable level of precision desired for portion control in industries such as the groceries, restaurants or industrial applications. While shown as being generally perpendicular to holding chamber 34, graduations 40 may be imprinted at any suitable angle to more accurately reflect the select volume of material 19 transferred to the holding chamber readied for dispensing. In addition, or as an alternative to graduations 40, a metering device 57 may be employed within holding chamber 34 to limit the maximum amount of materials 19 storable in the holding chamber prior to dispensing. Use of metering device 57 may be desirable under conditions where fixed amounts of materials 19 are to be dispensed, such as toppings for ice cream sundaes, among others. The size of metering device 57 is a function of the amount of material 19 to be dispensed. Metering device 57 may be a discrete component or may be fabricated as an integral part of stopper 58 or plunger 56. While shown in the figures as having a generally conical shape, other shapes, such as, without limitation, cylindrical, may be employed.

With continued reference to FIGS. 2 and 10b.1, a feed port 42 is located along a portion of holding chamber 34. Feed port 42 provides communication between holding chamber 34 and reservoir 16 through which material 19 stored within the reservoir is transferred into the holding chamber, as will be further described below. Feed port 42 can have any desired diameter, cross-section, length and orientation compatible with bin 10, body 12, dispensing chute 14. the material 19 to be dispensed. Typically, feed port 42 is of a generally rectangular or circular cross-section and has a cross-sectional width equal to or less than the width of holding chamber 34. The length of feed port 42 is geneally designed to be no longer than functionally necessary considering compatibility and connectability between body 12 and dispensing chute 14, but may be of any desired length. Further, feed port 42 is typically oriented such that when bin 10 is in a dispensing orientation, as described below and shown in FIGS. 10b.2-10d, the feed port is oriented at an upward angle from reservoir 16 to holding chamber 34, as depicted in FIGS. 10b.2-10d. The upward angle and relative size and shape of feed port 42 are configured to obstruct the flow of additional material 19 from reservoir 16 into holding chamber 34 when bin 10 is oriented in the dispensing orientation. While the dispensing and transfer orientations have been described

Spout 36 is located near one end of holding chamber 34 and forms the dispensing portion of dispensing chute 14 as depicted in FIGS. 1-5 and 10a-10d. Spout 36 may be of any desirable shape and size for directing predetermined amounts of material 19, queued up within holding chamber 34, as they are dispensed from dispensing chute 14. Typically, spout 36 is cylindrical in shape and has a diameter larger than that of holding chamber 34 to accommodate the free flow of material 19 upon dispensing. At the upper end of spout 36 where it transitions with holding chamber 34, is a circumferential ledge portion that forms a stopper seat 66, as described below, for stopper 58. At the opposite, dispensing end of spout 36, may be an inwardly sloping section that may form a funnel shape (FIGS. 1-3, 5 and 10a-10d) for directing dispensed material 19 into a desired container 43 as depicted in FIGS. 10c and 10d.

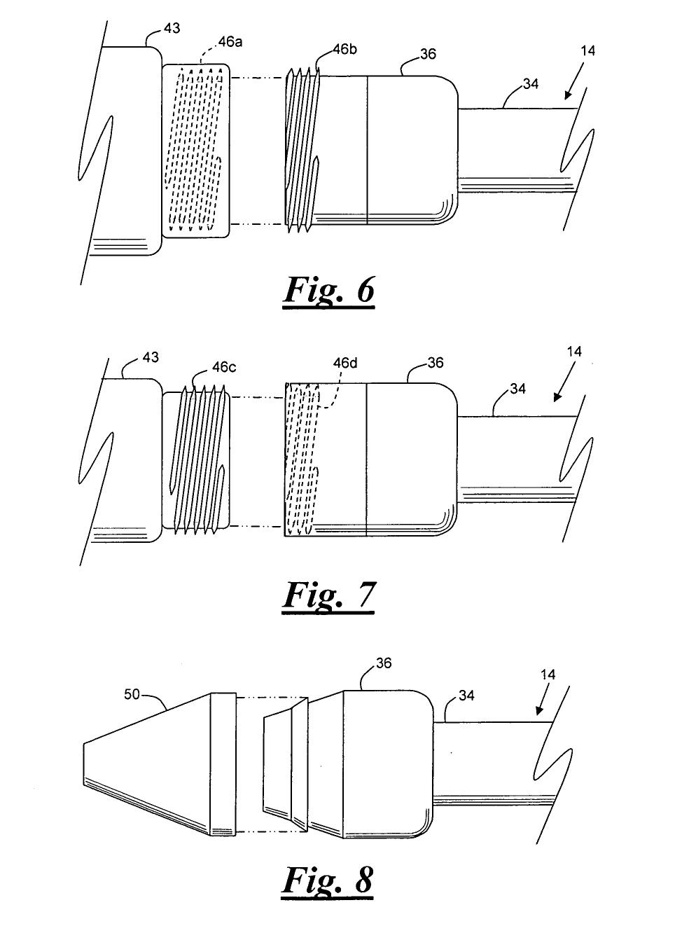

Other features may be located along or near the lower end of spout 36 to provide assistance with dispensing and adaptability to containers 43, as shown in FIGS. 6-8, into which material 19 are to be dispensed. Such features include bag grips 44, threads 46, a positive stop 48 and/or an adapter 50. Bag grips 44, as depicted in FIGS. 1, 2, 3, 5 and 10d, form a plurality of small ridges, bumps, or friction points along an outer surface of spout 36 to provide assistance to a user in retaining a bag around the spout during dispensing of material 19 into the bag. Bag grips 44 may encircle the entire lower end of spout 36 or only traverse a portion of the surface as depicted in FIGS. 1, 2, 3 and 5.

Referring now to FIGS. 6 and 7, spout 36 may be configured to couple directly to a container 43. Threads 46b or 46d may be located along an exterior or interior surface of spout 36 and are designed to correspond with threads 46a or 46c, respectively, of a desired container 43 into which material 19 are to be dispensed. This enables the container 43 to be coupled directly to the spout 36 by engaging the threads 46a and 46b or 46c and 46d. Such a threaded design may provide substantially complete containment of the dispensed material 19, thereby decreasing spillage or risk of contamination of the material during dispensing and eliminate the need for intermediated containment.

Depicted in FIGS. 2, 3 and 5, positive stop 48 is formed by a raised ring of material extending outwardly from the outer surface of spout 36 or raised tabs, ridges, a widening of the spout or other feature. Positive stop 48 is designed to obstruct insertion of spout 36 into a container 43 beyond the depth allowed by the positive stop. The obstruction to further insertion provided by positive stop 48 provides a user with positive feedback that spout 36 is fully engaged within a container 43 to be filled. Positive stop 48 may also be used to engage a plastic bag, as shown in FIG. 10d, by a user's hand or fingers 49 or with the assistance of a retaining device such as a rubber band (not shown).

FIG. 8 depicts an adapter 50 with spout 36. Adapter 50 removeably engages spout 36 using conventional clips, tabs, or other forms of press-fit type connection and is preferably attached to the spout when needed or detached when not needed. Adapter 50 can be designed as funnel-shaped to provide compatibility of spout 36 with containers 43 having fill openings smaller in diameter than the spout, as depicted in FIG. 8, or may have any other desirable shape including, for example, that of a threaded cylinder as described above and depicted in FIGS. 6 and 7.

Referring again to FIG. 2, dispensing mechanism 38 is contained within dispensing chute 14. Dispensing mechanism 38 comprises an actuator 52 such as a button, a spring 54, a plunger 56 and a stopper 58. Actuator 52 is located within and extends from the actuator portion of dispensing chute 14, and is generally located opposing spout 36. Actuator 52 inserts into the end of dispensing chute 14 and is biased outwardly therefrom by spring 54. Actuator 52 may have at its end surface, furthest from dispensing chute 14, a recess 60. Recess 60 may provide a depression to assist a user in locating a finger on actuator 52 for depressing the button during dispensing of material 19. Within recess 60 may also be placed a label or other indicia (not shown) to notify a user of one or more properties of materials 19 contained within bin 10, such as whether a contained spice is organic or non-organically grown, among others.

A biasing mechanism, such as spring 54, is located within dispensing chute 14 and biases actuator 52 to extend outwardly from the end of the dispensing chute. By doing so, spring 54 also biases stopper 58 in a closed sealed position against stopper seat 66, as will be described further below, and button seat 62 against button stop 64. Spring 54 is typically located between actuator 52 and a button stop 64 and may comprise any suitable form of spring or biasing mechanism, such as but not limited to helical springs, coil springs, compression spring, compression bladder, tension spring, or torsional springs, among others.

Plunger 56 is typically a rod-shaped member that provides an axis for mounting the moving elements of dispensing mechanism 38. Plunger 56 can have any suitable size, shape and composition compatible with dispensing mechanism 38, dispensing chute 14 and bin 10. Plunger 56 may be fabricated from plastic or metal, among other materials, and engages actuator 52 at one end and stopper 58 near the opposite end. The connection between plunger 56, actuator 52 and stopper 58 may be made by glues, adhesives, screw threads, pins, or clips, among other suitable attachment means given the design. In the alternative, all or a portion of plunger 56 may be fabricated as a single, integrated component by molded, machining or other methods of manufacture. By having button actuator 52 in communication with stopper 58 as components of plunger 56, the bias provided by spring 54 to the button is also provided to the stopper and button seat 62. A button stop 64 is fixed and attached along the length of plunger 56. Button stop 64 confronts button seat 62 to retain button actuator 52 and stopper 58 in their desired extended and closed positions respectively and may provide a seal against the button seat, thus preventing migration of materials 19 from around button actuator 52 during use.

Stopper 58 is attached near the lower end of plunger 56 opposite actuator 52. Stopper 58 is biased in a closed position by spring 54 against a stopper seat 66. Stopper 58 may be fabricated from a resilient material or include a resilient surface for sealing purposes with stopper seat 66. Stopper seat 66 may comprise merely the end of holding chamber 34 or a widened, transitional portion thereof providing a surface with which stopper 58 may interact and form a seal. In the closed position, as depicted in FIG. 2, stopper 58 provides a seal between the interior of holding chamber 34 and bin 10, and the outside environment. Stopper 58 may be of any desired size and shape but generally has the same, but slightly larger, cross-sectional shape as holding chamber 34 such that the stopper may seal off the end of the holding chamber. Stopper 58 may be made of any desirable material or combination of materials including plastics, rubbers, and metals among others and may utilize features such as O-rings, cup seals or gaskets, among others, to provide an adequate seal. Metering device 57 may be installed in conjunction with plunger 56 and may comprise a discrete component or be formed as an integral part of stopper 58.

With continued reference to FIG. 2, dispensing chute 14 has a portion along feed port 42 which forms a coupling 68 for connecting the dispensing chute to body 12. Body 12 also has a portion along a surface forming a press fit mating coupling 68. Coupling 68 provides the attachment of body 12 and dispensing chute 14 where the body and dispensing chute are constructed as separate components. In embodiments wherein body 12 and dispensing chute 14 are integrated then no coupling 68 is needed. Coupling 68 provides cooperating male and female fittings or other mating structures along body 12 and dispensing chute 14 and the attachment of those features is retained by fittings or fixtures along their adjoining surfaces, such as tabs, notches, lips, ridges, grooves, threads, screws or clips, among others, hereinafter generally referred to as tabs 70. If desired, coupling 68 may be made permanent by welding, gluing or otherwise permanently joining the mating sections. Further, if desired, O-rings, gaskets or other sealants may be utilized to provide a seal around coupling 68 that will resist the migration of granular or powdered material 19 from the mechanical joints of bin 10 as it is handled by the user. A removable coupling 68 is preferred in order to allow disassembly and cleaning of bin 10 and to fulfill NSF International requirements for use of the bin with food products.

Dispensing chute 14 and dispensing mechanism 38 components may be constructed of molded, generally clear plastic, but other color configurations are anticipated. Example materials include polycarbonates such as Lexan® produced by General Electric, Merlon® produced by Mobay Chemical Company, Markolon® produced by Bayer, or polyethylene terephthalates, among other materials. For food related dispensers, it is also preferable to utilize materials that have been approved by the U.S. Food and Drug Administration and constructed in accordance with food service specifications promulgated by NSF International of Ann Arbor, Mich. Where O-rings are utilized they may be made of any suitable materials such as food grade 75 Viton®, among others.

According to an embodiment of the present invention body 12 and dispensing chute 14 are manufactured as separate molded pieces. All surface and design features such as handle 18, fill line 24, grip 32 and coupling 68, among others are preferably molded in situ. Bin 10 may be assembled by first installing dispensing mechanism 38 within dispensing chute 14. To do so, plunger 56 is preferably fabricated with threads at its upper end (not shown) and button stop 64 is affixed intermediate the plunger's length. Stopper 58 is affixed near the lower end of the plunger and seats against stopper seat 66 while at rest. Plunger 56, stopper 58 and button stop 64 are then inserted into the lower, spout 36 end of dispensing chute 14 such that the upper, threaded end of the plunger is inserted first. The components are inserted by passing plunger 56 through spout 36, holding chamber 34 and button seat 62 until stopper 58 is seated against stopper seat 66. Spring 54 is then inserted into the opposite end of dispensing chute 14, around plunger 56 and seated against button seat 62. Actuator 52 is then affixed to the upper end of plunger 56 and against spring 54 preferably by screwing onto threads on the upper end of the plunger, both the end of the plunger and the button having mating, threaded sections (not shown).

Still referring to FIG. 2, dispensing chute 14 is attached to body 12 by inserting the male portion of coupling 68 located on the top surface of the body into the female portion of the coupling located along and around feed port 42 of the dispensing chute. Tabs 70 on each portion of coupling 68 engage each other by press-fit to retain the attachment between body 12 and dispensing chute 14.

Refer now generally to FIGS. 10a-10d. To begin operation, bin 10 is initially filled with a desired bulk material 19, such as spice, by first uncoupling body 12 from dispensing chute 14 to expose filling port 20 along the top surface of the body. Material 19 is poured, or by other means transferred, into reservoir 16 via filling port 20. Fill line 24 may be used in this process to determine how much material is to be placed in reservoir 16. The construction of body 12 from generally transparent or translucent polycarbonate or other plastic further enables a user to visually determine the quantity of material 19 placed into reservoir 16. Once a desired amount of material has been transferred to the reservoir 16, body 12 and dispensing chute 14 are re-coupled and bin 10 is stored until needed, such as depicted in FIGS. 9 and 10a.

As shown in FIG. 9, in one embodiment of the present invention bin 10 is sized to enable multiple bins to be stored in conventional 4 foot wide by 6 inch deep shelving unit 72 as may typically be found in retail grocery stores.

During storage, such as on a shelving unit described above, bin 10 is preferably placed on its feet 30, as depicted in FIGS. 1, 4 and 10a. The storage orientation of bin 10 is such that feet 30 are in contact with the shelf surface and dispensing chute 14 is located above body 12. In this orientation handle 18 is facing the user and away from the shelving unit and spout 36 is facing away from the user and toward the shelving unit 72. Such an orientation minimizes potential contamination of the spouts 36 by users and enables the users to easily view any labels 28, wherever they may be located on bin 10, and any indicia on recess 60 of actuator 52.

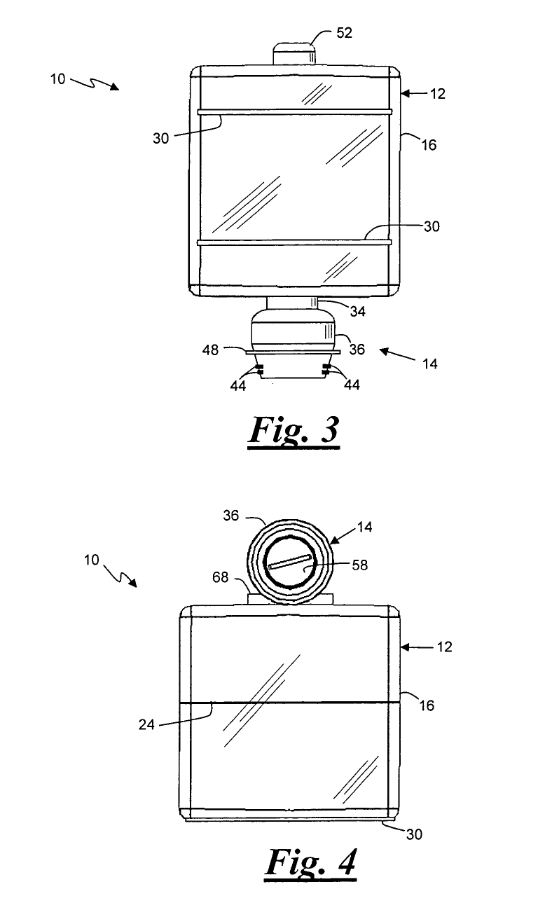

Refer now to FIGS. 9-10d for a discussion of the dispensing operation. To dispense the contained material 19, a user may locate and select a bin 10 using information contained on labels 26. If stored in a shelving unit 72, the user may retrieve the bin from the shelving unit or from another storage location by grasping handle 18 to remove the bin from its stored location. The user then inverts bin 10 such that dispensing chute 14 is oriented beneath body 12 in a transfer orientation, as depicted in FIG. 10b.1. The user then manually agitates bin 10 sufficiently to cause the desired amount of material 19 within reservoir 16 to flow through feed port 42 and into holding chamber 34. In addition to causing material 19 to flow into holding chamber 34, agitation may also provide the benefit of breaking up the material and hindering its ability to bridge or clog within reservoir 16, feed port 42 or the holding chamber due to tactile pressures between the particles of material, thereby increasing the material's flowability. Once a sufficient quantity of material 19 has moved into holding chamber 34 the user then re-orients bin 10 to a dispensing orientation such that dispensing chute 14 is aligned generally vertically with spout 36 located along the bottom end, as depicted in FIGS. 3, 5 and 10b.2, and the amount of material in the holding chamber can be measured. When in the dispensing orientation the upwardly angling design of feed port 42 does not allow material 19 to continue to flow into holding chamber 34. The user then uses graduations 40 along holding chamber 34 to measure the quantity of material 19 contained therein. If the desired amount of material 19 is contained within holding chamber 34 then the user proceeds to dispensing. If such is not the case, the user may again re-orient bin 10 in the storage orientation, see FIG. 10a, or in the transfer orientation, see FIG. 10b.1, and agitate the bin to cause material 19 to flow back into reservoir 16 or to cause more material to flow into holding chamber 34, respectively. This process may be followed until achieving the desired (measured) amount of material 19 in holding chamber 34 for dispensing. If plunger 56 has been fitted with metering device 57, the dispensing operation is similar to that previously described except that, instead of using graduations 40 to determine the amount of materials 19 to be dispensed, the user agitates the bin 10 until the dispensing portion of the holding chamber 34 is topped off with materials, as shown in FIG. 10b.2. Thus, when actuator 52 is engaged, a select volume of material 19, predetermined by the size of the holding chamber 34 and the volume of the metering device 57, is dispensed. See, e.g., FIG. 10.c.

To dispense material 19 from dispensing chute 14 the user, grasping bin 10 by handle 18, may couple or orient spout 36 to communicate with a desired container 43 or over a desired dispensing location while maintaining the bin in the dispensing orientation, see FIGS. 10c and 10d. Where material 19 is to be dispensed into a bag 74 the user may hold the bag opening around spout 36 with fingers 49 and may utilize bag grips 44 in retaining the bag in position. Where a container 43, such as a conventional-sized spice jar, is utilized the user may wish to employ threads, see FIGS. 6 and 7, spout adapter 50, see FIG. 8, or positive stop 48, see FIGS. 2, 3 and 5, to assist in properly coupling spout 36 with the container. To dispense material 19 the user manually depresses and holds actuator 52 in a dispensing state, thereby compressing spring 54 against button stop 64, longitudinally translating plunger 56 toward spout 36 and extending stopper 58 away from stopper seat 66 and the end of holding chamber 34, as depicted in FIGS. 10c and 10d. Material 19 then flows around stopper 58, through spout 36 and into the desired container 43, bag 74 or other receptacle. After material 19 has been dispensed the user removes force from actuator 52 and allows spring 54 to return the components of dispensing mechanism 38 to their original, at rest, positions to seal dispensing chute 14 from the outside environment. Bin 10 may then be returned to storage or the above process followed again for subsequent dispensing.

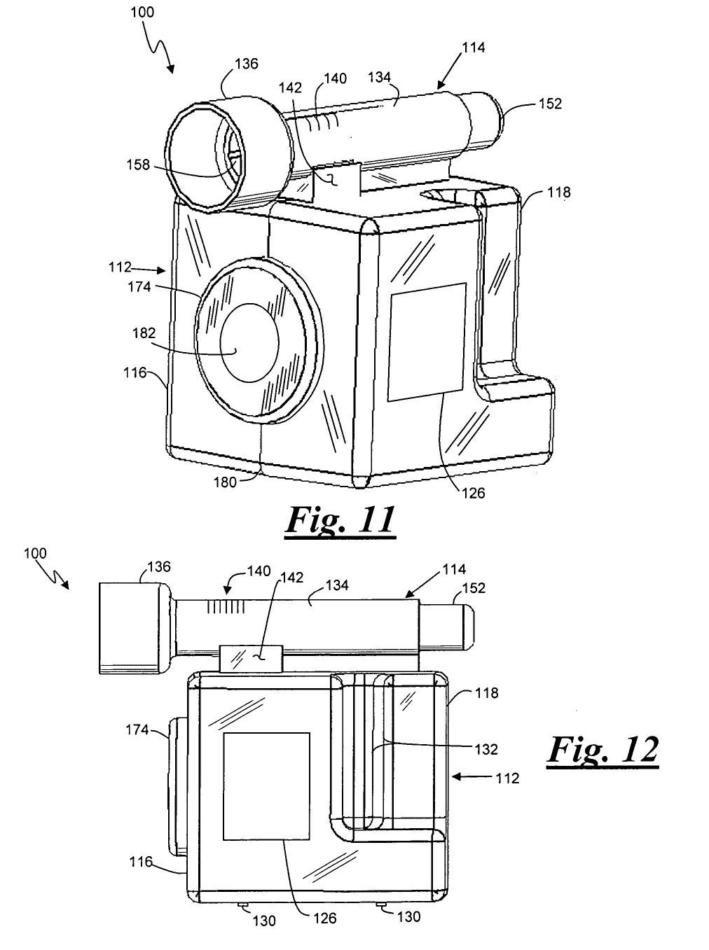

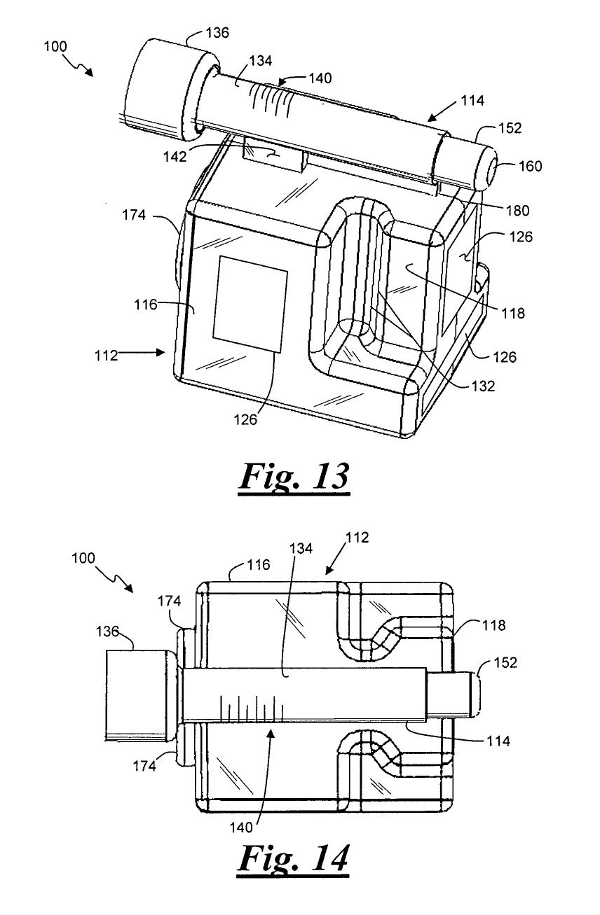

Referring now to FIGS. 11-16 a bin 100 is disclosed according to a second embodiment of the present invention. Bin 100 is comprised of body 112 which may be of conventional design including, without limitation, molded halves mated together along a parting line 180 and joined together to form the body, as depicted in FIG. 11. Body 112 is fitted with a lid 174 to provide access to reservoir 116 and which provides a seal against outside contaminants. Lid 174 may be child-safe or tamper-proof to provide greater control of access to and deter contamination of material 19 within bin 100. Lid 174 may also be provided with a label 182 along its surface to assist a user in identifying the contents of bin 100. Attached to the front face of body 112 via a feed port 142 is a dispensing chute 114. Dispensing chute 114 is shown with a set of graduations 140 to aid the consumer in determining the amount of material 19 being dispensed. While shown as being generally perpendicular to the dispensing chute 114, graduations 140 may be angled, as well, to correspond with dispensing orientations other than vertical. At one end of dispensing chute 114 is button 152 which, when actuated, enables material 19 that is temporarily retained in holding chamber 134 to be dispensed from spout 136.

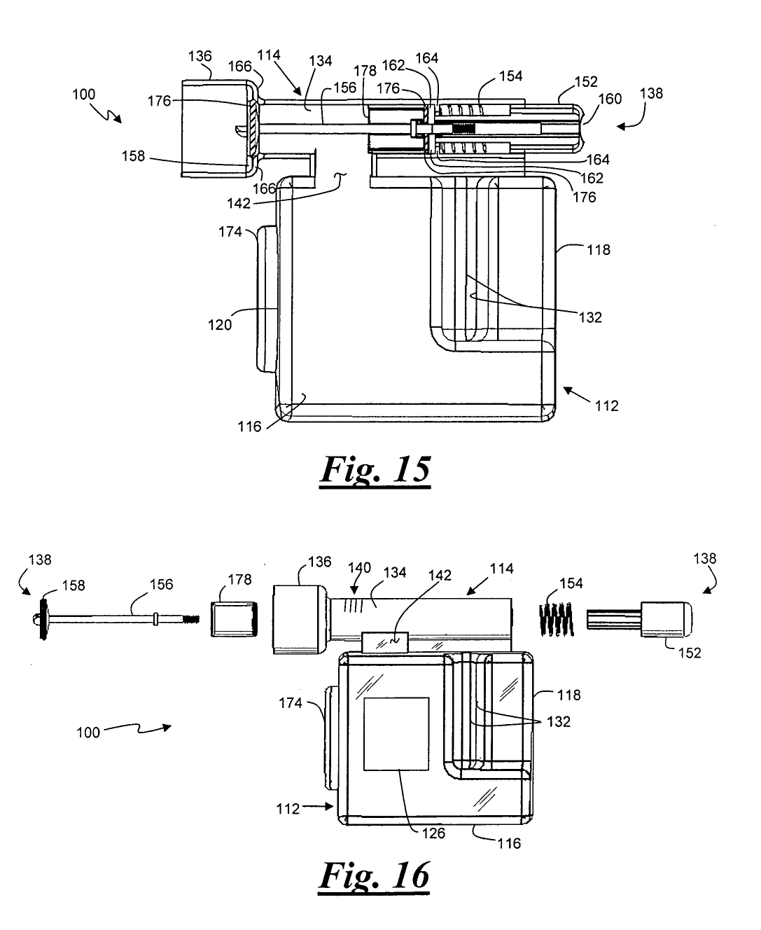

Referring to FIGS. 15 and 16, bin 100 is shown in cross-sectional and exploded, side elevational views, respectively. Here the operational elements corresponding to dispensing mechanism 138 can be seen. When assembled, button actuator 152 is biased in its outwardly extended location by the action of spring 154 acting against button seat 162 (FIG. 15), an inner structure to dispensing chute 114. Button actuator 152, in turn, confronts a door 178, which is held into confronting contact with the button by a threaded portion of plunger 156. Door 178 is an articulating, cylindrical element that works in conjunction with the dispensing button actuator 152 to cover and seal feed port 142 during the dispensing of the pre-determined product portion. One end of plunger 156 is threaded to engage stopper 158, which is biased against stopper seat 166 (FIG. 15) by spring 154 while button actuator 152 is at rest. As described in another embodiment, a metering device, such as discussed at reference number 57 in connection with FIG. 2, may be located within dispensing chute 114 to limite the amount of material dispensed per actuation of actuator 152.

Referring again to FIGS. 11-16, the operation of bin 100 will be discussed. A predetermined bulk material 19 is loaded into reservoir 116 via filling port 120 after removing lid 174. Once loaded, sealed lid 174 becomes the base of the bin 100 when the bin is in the dispensing orientation described above. The consumer may engage bin 100 by holding onto handle 118, orienting the bin in the transfer orientation and agitating the bin containing the stored material 19 until the desired amount of material passes through feed port 142 into dispensing chute 114. The user can then re-orient bin 100 to the dispensing orientation and utilize graduations 140 on the outside of holding chamber 124 to gage the amount of material 19 located in the chute in preparation of being dispensed. Once the desired amount of material 19 has been channeled into holding chamber 134, the consumer while retaining bin 100 in the dispensing orientation, such that spout 136 and lid 174 are directed downwardly, and then depresses button actuator 152. Upon actuation of button actuator 152, stopper 158 is unseated from stopper seat 166, thereby permitting material 19 previously stored within holding chamber 134 to be dispensed from spout 136. Door 178 is sized corresponding to the inner circumference of dispensing chute 114 to act as a sliding seal to cover feed port 142 when button 152 is depressed, thus preventing additional material 19 from exiting feed port 142 during the dispensing process. Bag grips, similar to those depicted at 44 in FIG. 1, may be provided on the outside surface of spout 136 to aid the consumer with the engagement of a bag receptacle (not shown) for receiving material 19 being dispensed. However, other receptacles, such as preformed plastic or paper cups (not shown) may be employed for receiving predetermined amounts of dispensed material 19. In addition, such preformed receptacles may be supplied with lids (not shown) having outer surfaces with a suitable finish that would accept ink or pencil markings as indicia of the receptacle's content. In this manner, the receptacle used to dispense the material 19 may also provide additional duty as the storage container at the consumer's facility.

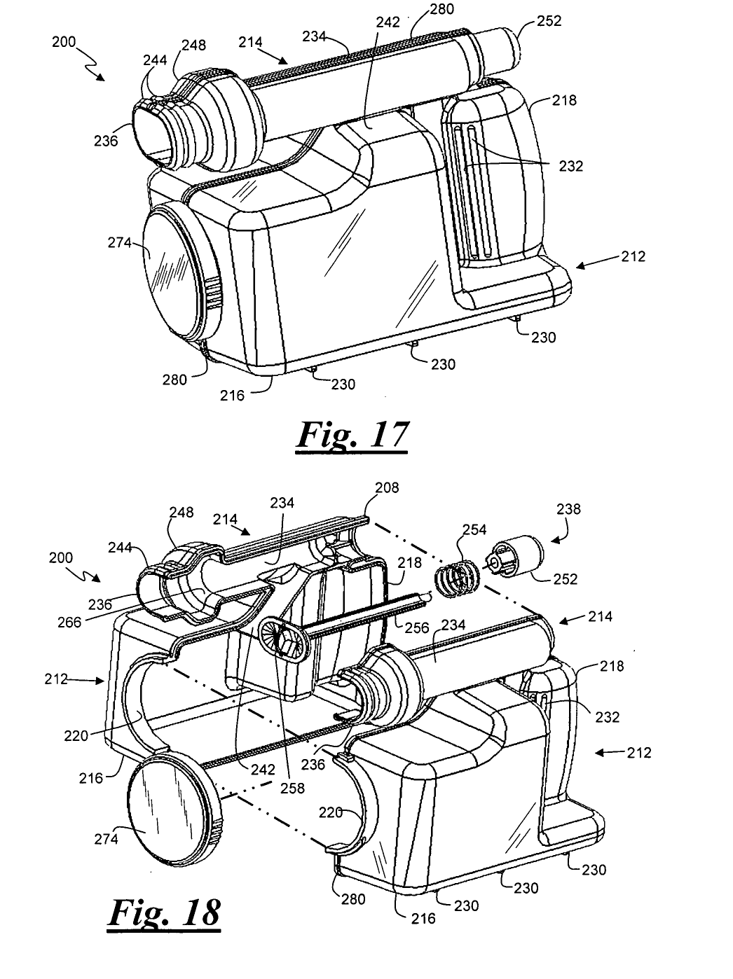

Referring now to FIGS. 17 and 18 a bin 200 is depicted according to another embodiment of the present invention. Bin 200 is constructed in a manner much the same as bin 100 described previously. Body 212 and dispensing chute 214 of bin 200 are joined as a single unit after being molded as two halves. As depicted in FIG. 18 the two halves may be mated and attached along a parting line 280 and dispensing mechanism 238 components integrated within. A lid 274 is also provided to seal reservoir 216 from the outside environment. Spout 236 is supplied with an oblong cross-sectional shape as well as with a plurality of bag grips 244 encircling the full circumference of the spout. An integrated positive stop 248 also is supplied by a widened section of spout 236. Handle 218 is rounded to provide increased user comfort and grip when handling bin 200 as well as to provide an aesthetic design. Further, handle 218, reservoir 216 and feed port 242 are designed to provide greater compactness to bin 200 as well as to increase the total reservoir volume available for storing material 19. By this design, bin 200 operates identically to bin 10, above, for storage and dispensing, and is filled in the same manner as bin 100 above. As described in another embodiment, a metering device, not shown by essentially as shown in FIG. 2 at reference number 57, may be located within dispensing chute 214 to limit the amount of material dispensed per actuation of button actuator 252.

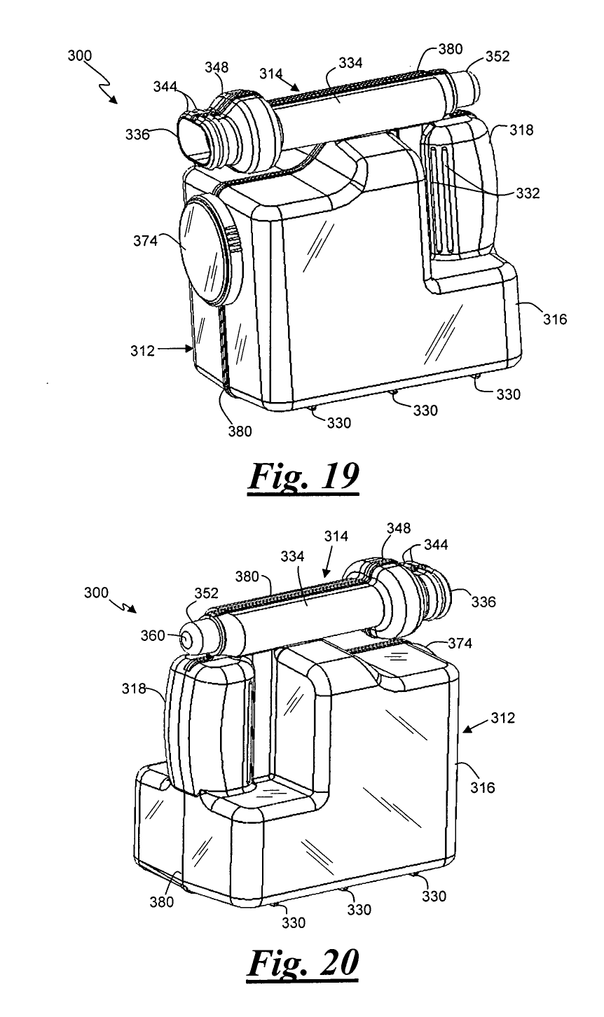

Referring now to FIGS. 19 and 20, a bin 300 is depicted according to yet another embodiment of the present invention. Bin 300 is identical in design and operation to bin 200 except for an increase in the height of body 312 of the bin. Increasing the height of body 312 of bin 300 provides a greater volume to reservoir 316 for storing material 19. Such an increase may decrease the frequency that a user must refill bin 300 and may also require a different size of storage unit for storing the bins.

While this invention has been shown and described with respect to a detailed embodiment thereof, it will be understood by those skilled in the art that changes in form and detail thereof may be made without departing from the scope of the claims of the invention.

What is claimed is:

1. A bin for dispensing bulk materials, comprising:
a body having a fillable reservoir for storing the bulk materials; and
a selectably closable dispensing chute in communication with the reservoir,
wherein a select portion of the bulk material is transferred from the reservoir to the dispensing chute by orienting the bin in a transfer orientation, and
wherein the select portion is dispensed from the dispensing chute by opening the dispensing chute while orienting the bin in a dispensing orientation.

2. The bin of claim 1, further comprising a feed chute extending between the reservoir and the dispensing chute.

3. The bin of claim 2 wherein the feed chute is configured to deter transfer of bulk material from the reservoir to the dispensing chute when the bin is in a storage orientation.

4. The bin of claim 1 wherein the body further comprises a handle portion.

5. The bin of claim 4 wherein the handle portion further comprises a plurality of grips.

6. The bin of claim 1 wherein the body further comprises an identification label.

7. The bin of claim 1 wherein at least one of the body and the dispensing chute are one of generally transparent and translucent.

8. The bin of claim 7 wherein the body further comprises a fill line.

9. The bin of claim 7 wherein the dispensing chute further comprises a plurality of graduations to measure the portion of bulk material selected.

10. The bin of claim 1 wherein the dispensing chute is detachably coupled to the body.

11. The bin of claim 1, further comprising a selectable closure in the body for transferring bulk material into the reservoir.

12. The bin of claim 1 wherein the dispensing chute is closed off from the reservoir when the dispensing chute is opened for dispensing.

13. The bin of claim 1 wherein the dispensing chute further comprises a spout having at least one of a conical shape, threads to couple to a container, a plurality of bag grips, and a positive stop.

14. The bin of claim 1 further comprising a metering device within the dispensing chute.

15. A method for dispensing bulk materials, comprising the steps of:
providing a body having a fillable reservoir for storing the bulk materials;
placing a selectably closable dispensing chute in communication with the reservoir,
transferring a select portion of the bulk material from the reservoir to the dispensing chute by orienting the bin in a transfer orientation; and
dispensing the select portion from the dispensing chute by opening the dispensing chute while orienting the bin in a dispensing orientation.

16. The method of claim 15, further comprising the step of coupling a feed chute between the reservoir and the dispensing chute.

17. The method of claim 16, further comprising the step of configuring the feed chute to deter transfer of bulk material from the reservoir to the dispensing chute when the bin is in a storage orientation.

18. The method of claim 15, further comprising the step of adding selectable closure in the body for transferring bulk material into the reservoir.

19. The method of claim 15, further comprising the step of closing off the dispensing chute from the reservoir when the dispensing chute is opened.

20. The method of claim 15, further comprising the step of coupling to the dispensing chute a spout having at least one of a conical shape, threads to couple to a container, a plurality of bag grips, and a positive stop.

21. The method of claim 15, further comprising the step of using a metering device within the dispensing chute to determine the select portion of bulk material to be dispensed.

22. A bin for dispensing bulk materials, comprising:
a body having a handle portion and a fillable reservoir for storing the bulk materials;
a selectably closable dispensing chute in communication with the reservoir through a feed chute extending between the reservoir and the dispensing chute; and
a spout having at least one of a conical shape, threads to couple to a container, a plurality of bag grips, and a positive stop;
wherein a select portion of the bulk material is transferred from the reservoir to the dispensing chute by orienting the bin in a transfer orientation, and
wherein the select portion is dispensed from the dispensing chute by opening the dispensing chute while orienting the bin in a dispensing orientation.
